(19) United States
(12) Patent Application Publication
(10) Pub. No.: US 2017/0172182 A1
(43) Pub. Date: Jun. 22, 2017

(54) PRE-MUDDLED DRINK MIX AND METHOD OF MAKING

(71) Applicant: Courtney J. Chappell, Austin, TX (US)

(72) Inventor: Courtney J. Chappell, Austin, TX (US)

(21) Appl. No.: 15/386,620

(22) Filed: Dec. 21, 2016

Related U.S. Application Data
(60) Provisional application No. 62/270,519, filed on Dec. 21, 2015.

(51) Int. Cl. A23L 2/02; A23L 2/60; A23L 2/52

(52) U.S. Cl. CPC A23L 2/02; A23L 2/52; A23L 2/60; A23V 2002/00

(57) ABSTRACT

A pre-packaged mixture of ingredients for making a beverage and method of making is provided. The mixture includes muddled ingredients, including, at least in part, pre-washed, pre-sized fresh ingredient(s), and optionally, additional ingredients. The muddled, and optional ingredients are package in measured amounts, such for preparing a single beverage and/or for preparing a bulk quantity of beverages. The mixture is an all-inclusive mix to which a prescribed amount of alcohol can be added or directly included in the mix to provide a finished, fresh adult beverage.

### CROSS-REFERENCE TO RELATED APPLICATION

This application claims the benefit of U.S. Provisional Application Ser. No. 62/270,519, filed Dec. 21, 2015, which is incorporated herein by reference in its entirety.

### BACKGROUND OF THE INVENTION

1. Technical Field

This invention relates generally to beverages, and more particularly to beverages and mixes therefor, containing fresh ingredients and to their method of making.

2. Related Art

Many beverages are made to include fresh ingredients, wherein the fresh ingredients are stocked and prepared individually and mixed together while making the particular beverage. In order to properly prepare these beverages, it is necessary to properly stock the individual ingredients to best prevent them from spoiling, wherein most have a relatively short stock life regardless of how they are stored, such as various types of fresh fruits, herbs and the like. Then, upon receiving the particular beverage order, the proper ingredients must be gathered and further prepared, with at least some of the ingredients often requiring washing, tearing, slicing or mincing. Further yet, many beverages call for muddling at least some of the prepared ingredients with one another. Accordingly, the preparation process require use of a wash basin as well as knives, cutting surfaces and specialty muddling tools, often referred to a pestle and mortar. This process not only requires having the fresh ingredients, wash basin, preparation area and tools readily available, but further, generally take several minutes, which can be very costly in a busy restaurant or tavern environment, both from requiring the customer to wait and also from potentially losing additional sales that could have been obtained if not for the delay. Further yet, having to maintain fresh ingredients in stock can also prove costly, not only from occupying valuable shelf or refrigerator space, but also from having to throw out spoiled product that goes unused within the shelf life of the product.

### SUMMARY OF THE INVENTION

In accordance with one aspect of the invention, a pre-packaged mixture of ingredients for making a beverage is provided. The mixture includes muddled ingredients, including, at least in part, pre-washed, pre-sized fresh ingredient(s). The muddled ingredients are package in pre-measured amounts, such for preparing a single beverage and/or for preparing a bulk quantity of beverages.

In accordance with another aspect of the invention, the pre-packaged mixture is hermetically sealed to provide the mixture with a long stock life.

In accordance with another aspect of the invention, the pre-packaged mixture includes ingredients in addition to the pre-muddled ingredients.

In accordance with another aspect of the invention, the pre-packaged mixture includes pre-muddled ingredients, wherein at least some of the ingredients are muddled separately from one another and subsequently mixed together to provide an optimal flavor profile.

In accordance with another aspect of the invention, the pre-packaged mixture is at least one of ambient temperature shelf-stable, freezable, refrigerateable, canned, freeze dried, flash-frozen, pasteurized, or the like.

In accordance with another aspect of the invention, the pre-packaged mixture can include high pressure processed ingredients.

In accordance with another aspect of the invention, a method of making a pre-packaged mixture of ingredients for a beverage is provided. The method includes washing at least some of the ingredients; sizing the ingredients and muddling at least some of the washed ingredients. Then, packaging the muddled ingredients in pre-measured amounts, such for preparing a single beverage and/or for preparing a bulk quantity of beverages.

In accordance with another aspect of the invention, the method can include automating the pre-packaging process of the mixture.

In accordance with another aspect of the invention, the method includes hermetically sealing the packaged mixture to provide the mixture with a long stock life.

In accordance with another aspect of the invention, the method can include adding supplemental ingredients to the mixture in addition to the muddled ingredients prior to packaging.

In accordance with another aspect of the invention, the method can include muddling at least some of the ingredients separately from one another and then mixing the separately muddled ingredients with one another prior to packaging to provide an optimal flavor profile.

In accordance with another aspect of the invention, the method can include measuring the ingredients separately from one another and muddling at least some of the measured ingredients.

In accordance with another aspect of the invention, the method can include measuring the ingredients separately from one another, mixing at least some of the measured ingredients with one another and muddling the mixed ingredients.

In accordance with another aspect of the invention, the method can include packaging the mixture to be shelf-stable, freezable, or refrigerateable.

In accordance with another aspect of the invention, the method can include canning, freeze drying, pasteurizing, or flash-freezing the mixture.

In accordance with another aspect of the invention, a method of making a beverage is provided. The method includes opening a hermetically packaged mixture of ingredients including, at least in part, a muddled ingredient; adding a fluid to the ingredients and mixing or stirring the fluid and ingredients together.

In accordance with another aspect of the invention, the method of making a beverage can further include shaking the fluid and the ingredients together in a cocktail shaker.

In accordance with another aspect of the invention, a pre-packaged mixture of ingredients for making a beverage is provided, consisting of: muddled fresh ingredients; fruit juice; and sweetener.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIG. 1A is front view of a pre-packaged mixture of ingredients in accordance with one aspect of the invention for making a beverage;

FIG. 1B is a side view of the pre-packaged mixture of ingredients of FIG. 1A;

FIG. 1C is side view of a pre-packaged mixture of ingredients in accordance with another aspect of the invention for making a beverage;

FIG. 2 is a flow diagram illustrating a process for making a pre-packaged mixture of ingredients for a beverage in accordance with another aspect of the invention; and

FIG. 3 is a flow diagram illustrating a process for making a beverage in accordance with yet another aspect of the invention.

### DETAILED DESCRIPTION OF PRESENTLY PREFERRED EMBODIMENTS

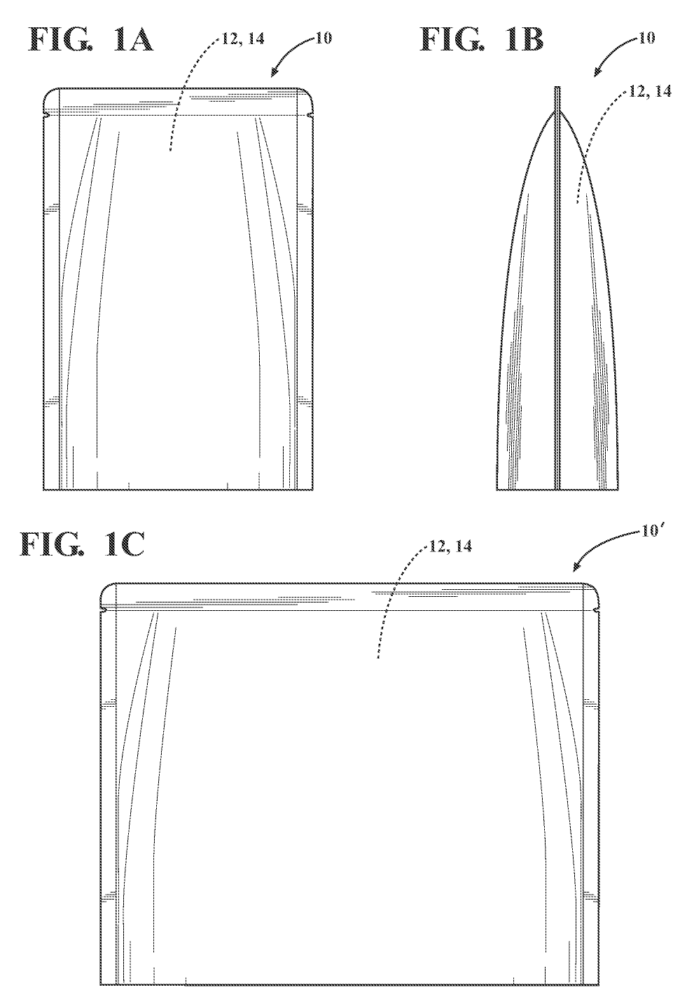

Referring in more detail to the drawings, FIGS. 1A-1B and 1C illustrate, respectively, a hermetically sealed package 10, 10′ containing a mixture 12 of pre-selected ingredients for making a beverage. The mixture 12 includes muddled ingredients 14, including, at least in part, pre-washed, pre-sized fresh (non-artificial), non-frozen ingredient(s), although it is contemplated that fresh frozen ingredients could be used; however, the mechanism and duration of freezing must not detract from the fresh flavor profile of the ingredients. The muddled ingredients 14 are package in pre-measured amounts, such for preparing a single beverage (FIGS. 1A-1B) and/or for preparing a bulk quantity of beverages (FIG. 1C). With the package 10, 10′ being hermetically sealed, and processed in accordance with the invention, the mixture 12 contained therein is provided with a long stock life, up to several months or longer. As such, the cost associated with spoiling of the mixture 12 is minimized. The package 10, 10′ can be prepared for storage in a variety of ways, such as being shelf-stable at ambient room temperature, freezable, and/or refrigerateable. Further, the package 10, 10′ could be canned, freeze dried, flash-frozen, pasteurized, or otherwise. If pasteurized, the package 10, 10′ can be pasteurized via a cold pasteurization process, such as via high pressure processing (HPP). In the HPP process, the package 10, 10′ is subjected to a hydrostatic pressure up to 600 MPa/87,000 psi for between about a few seconds to a few minutes. HPP is a natural, environmentally friendly process that respects the integrity of the ingredients, thereby maintaining the fresh food characteristics, including flavor and nutrients. Further yet, with each package 10, 10′ containing multiple ingredients, the amount of space required to stock the ingredients required to make the specified type of beverage is greatly reduced relative to that if the ingredients were stocked separately.

It should be recognized that the mixture 12 within the packages 10, 10′ can include ingredients, muddled and supplemental ingredients, required to make any desired beverage. By way of example and without limitation, the package 10, 10′ can include fresh ingredients required to make a mojito, including mint leaves, lime, and a sweetener, such as simple syrup. Other, supplemental ingredients can be added, of course, without departing from the spirit of the invention. As such, it is to be recognized that the ingredients included in the mixture 12 can be selected as desired in order to make any type of beverage ordinarily containing fresh, muddled ingredients. One possessing ordinary skill in the art of making beverages will readily appreciate the different muddled ingredients needed to make a selected beverage, with those mixtures being contemplated herein.

The pre-packaged mixture 12 includes pre-muddled ingredients, wherein at least some of the ingredients can be muddled separately from one another and then subsequently mixed together, thereby providing an optimal flavor profile of the individual ingredients. Of course, the ingredients can be muddled together as a mixture, optionally including supplemental ingredients, if desired, particularly if the separate ingredients are not susceptible to losing individual flavor profiles if mixed in advance of being muddled.

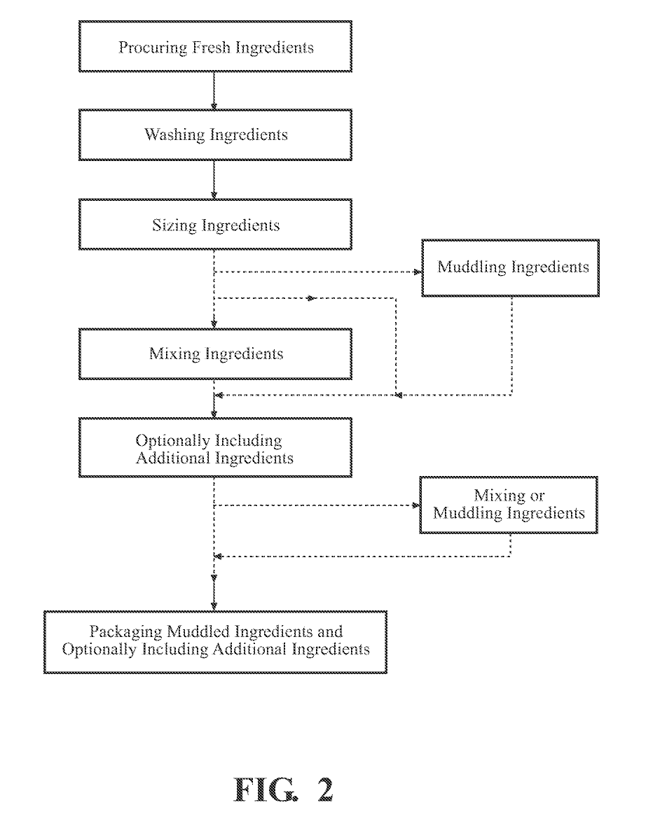

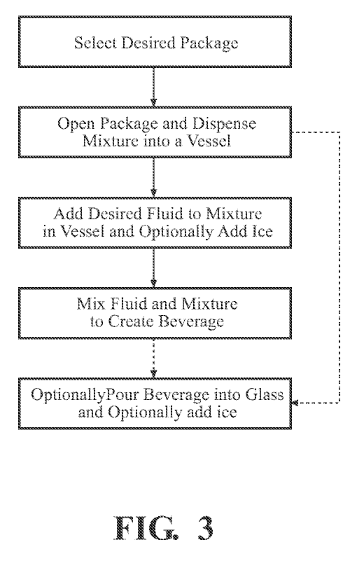

In accordance with another aspect of the invention, as illustrated in FIG. 2, a method of making a hermetically sealed package 10 of a mixture 12 of ingredients for a beverage is provided. The method includes washing at least some of the ingredients; sizing the ingredients and muddling at least some of the washed ingredients. Then, packaging the muddled ingredients, and other supplemental ingredients, as desired, such as simple syrup, by way of example and without limitation, in pre-measured amounts, such for preparing a single beverage and/or for preparing a bulk quantity of beverages. The washing can be performed as desired for the selected ingredient, including washing in relatively warm and/or cold water-based solutions, as desired for the type of ingredient. The sizing operation can include tearing, cutting, trimming, mincing, grating, muddling, or other pulverizing or comminuting processes, as necessary to produce the desired consistency of the selected ingredient. The muddling can be performed by hand, such as with a muddler tool, e.g. pestle and mortar, or via an automated muddling process, and in the desired serving proportions, whether individual or bulk.

In accordance with another aspect of the invention, the method can include adding supplemental ingredients to the mixture 12 in addition to the previously muddled ingredients prior to packaging. This may be desirable to provide an optimal flavor profile, depending on the nature of the ingredients included in the mixture 12.

In accordance with another aspect of the invention, the method can include muddling at least some of the ingredients separately from one another and then mixing the separately muddled ingredients with one another prior to packaging. This may be desirable to provide an optimal flavor profile, depending on the nature of the ingredients included in the mixture 12. Otherwise, the method can also include mixing the fresh ingredients, and optionally supplemental ingredients, together prior to muddling, and then subsequently mudding the entirety of the mixed ingredients together.

In accordance with another aspect of the invention, a method of making a beverage is provided. The method includes opening a hermetically sealed package 10 containing a mixture 12 of ingredients including, at least in part, a muddled ingredient. Then, optionally adding a fluid, such as alcohol, by way of example and without limitation, though it is contemplated that alcohol could be included in the mix, to the ingredients and mixing the fluid and ingredients together in a vessel, wherein the vessel could be a mixer, blender, glass or otherwise. The method can further include performing the mixing via stirring, shaking, blending, or otherwise. Depending on the type of vessel used, the mixed beverage can further be poured into a separate glass, and then, ice can optionally be added to the beverage. It has been learned that the resulting beverage has an enhanced flavor profile due to the package ingredients melding with one another over an extended period of time, without loss of flavor, due at least in part to the hermetically sealed packaging. It has been further found that the muddling helps to release the flavors of the fresh ingredients to better bind and mix homogenously with the added fluids and alcohol.

Many modifications and variations of the present invention are possible in light of the above teachings. It is, therefore, to be understood that the invention may be practiced otherwise than as specifically described, and that the scope of the invention is defined by any ultimately allowed claims.

What is claimed is:

1. A pre-packaged mixture of ingredients for making a beverage, comprising:
muddled fresh ingredients, including, at least in part, pre-washed, pre-sized fresh ingredient(s).

2. The pre-packaged mixture of claim 1, further including supplemental ingredients in addition to the muddled ingredients.

3. The pre-packaged mixture of claim 2, wherein at least some of the supplemental ingredients include fluid ingredients.

4. The pre-packaged mixture of claim 3, wherein the muddled ingredients are muddle in the supplemental ingredients.

5. The pre-packaged mixture of claim 1, wherein at least some of the ingredients are muddled separately from one another and subsequently mixed together

6. A method of making a pre-packaged mixture of ingredients for a beverage, comprising:
washing at least some of the ingredients;
sizing the ingredients;
muddling at least some of the washed ingredients; and
packaging the ingredients in a hermetically sealed package in pre-measured amounts.

7. The method of claim 6, further including providing the pre-measured amounts as an amount for a single beverage.

8. The method of claim 6, further including providing the pre-measured amounts as an amount for a bulk quantity of beverages.

9. The method of claim 6, further including automating the pre-packaging process.

10. The method of claim 6, further including adding at least one supplemental ingredient to the mixture in addition to the muddled ingredients prior to packaging.

11. The method of claim 10, further including muddling the ingredients prior to adding the at least one supplemental ingredient.

12. The method of claim 10, further including muddling the ingredients after adding the at least one supplemental ingredient.

13. The method of claim 6, further including muddling at least some of the ingredients separately from one another and then mixing the separately muddled ingredients with one another prior to packaging.

14. The method of claim 6, further including measuring the ingredients separately from one another and muddling at least some of the measured ingredients.

15. The method of claim 14, further including mixing at least some of the measured ingredients with one another and then muddling the mixed ingredients.

16. The method of claim 6, further including canning, freeze drying, refrigerating, pasteurizing, or flash-freezing the mixture.

17. The method of claim 16, further including pasteurizing the mixture in a hydrostatic pressurizing process.

18. A method of making a beverage, comprising:
opening a hermetically packaged mixture of ingredients including, at least in part, a muddled, fresh ingredient;
adding a fluid to the ingredients; and
mixing the fluid and ingredients together.

19. The method of claim 18, further including performing the mixing by one of shaking, stirring, or blending the fluid and the ingredients together.

20. A pre-packaged mixture of ingredients for making a beverage, consisting of:
muddled fresh ingredients;
fruit juice; and
sweetener.
